(19) United States
(12) Patent Application Publication
(10) Pub. No.: US 2008/0169312 A1
(43) Pub. Date: Jul. 17, 2008

(54) Dispenser with Sealed Dispensing Valve Unit

(76) Inventor: Jung Hyun Kee, Incheon (KR)

Correspondence Address: IPLA P.A., 3580 WILSHIRE BLVD., 17TH FLOOR, LOS ANGELES, CA, 90010, US

(21) Appl. No.: 10/595,573

(22) PCT Filed: Jan. 11, 2005
(86) PCT No.: PCT/KR2005/000082

§ 371 Date: Apr. 27, 2006

(30) Foreign Application Priority Data
Mar. 17, 2004 (KR) 20-2004-0007353

(51) Int. Cl. B67D 5/06; G01F 11/00; B65D 88/54

(52) U.S. Cl. 222/205; 222/321.6; 222/321.7; 222/256; 222/405

(57) ABSTRACT

A dispenser with a sealed dispensing valve unit is disclosed. The dispenser is secured to a mouth of a hermetic casing, and discharges contents through a center of an upper plate of a button. The dispenser includes an outlet hole (100) bored in a central portion of the button. An inclined inner surface defines a lower portion of the outlet hole, and a vertical inner surface extends from an upper end of the inclined inner surface to a predetermined height. The dispenser also includes a dispensing valve (200) having at a lower portion thereof an inclined outer surface to selectively come into contact with the inclined inner surface of the outlet hole due to operation of a pumping means, thus opening or closing the outlet hole. Further, a vertical outer surface extends upwards from an upper end of the inclined outer surface to a predetermined height.

### TECHNICAL FIELD

The present invention relates, in general, to dispensers and, more particularly, to a dispenser with a sealed dispensing valve unit, which has a plate button to dispense a prescribed amount of a cream-type cosmetic that has high viscosity and is easily deteriorated by contact with air, and which is constructed so that an outlet hole of the dispenser is completely sealed when the cosmetic is not in use, thus more effectively preventing the quality and color of contents from changing, and allowing the contents to be stored for a lengthy period of time.

### BACKGROUND ART

As is generally known, cream-type cosmetics, for example, nourishing cream or massage cream have a high oil content, so that they easily deteriorate, in comparison with other kinds of cosmetics.

Generally, the cream-type cosmetic is stored in a casing having a relatively large mouth so that a user may remove the cosmetic from the casing with her hand. However, such a casing increases the contact of the cosmetic with air, thus causing oxidation of the cosmetic. Further, the cosmetic may be deteriorated by foreign materials or water remaining on the user's finger.

Meanwhile, dispensers have been widely used in various fields to discharge a prescribed amount of contents from a casing. Such a dispenser is operated as follows. That is, when a button having at a predetermined position thereof a nozzle is pushed, a cylinder coupled to a lower portion of the button is compressed. Thus, contents flow along a narrow and long path, prior to being discharged through the nozzle which is provided at a predetermined position on the button.

In order to move contents along the narrow and long path, it is preferable that the contents have low viscosity.

That is, in the case of a cosmetic having relatively low viscosity, such as facial lotion or skin toner, the cosmetic easily moves along the narrow and long path when the dispenser is compressed. Conversely, in the case of a cream-type cosmetic having high viscosity, it is very difficult to move the cosmetic along the narrow path by a pumping action of the dispenser, so that it is inconvenient to dispense the cream-type cosmetic using the dispenser.

In order to solve the problem, Korean U.M. Registration No. 0247187 has been proposed, which was filed by the same applicant as the present invention. The utility model provides a dispenser which hermetically covers an upper portion of a casing, with a plate button secured to an upper portion of the dispenser, and an outlet hole formed on a center of the button. When the button is pressed down, contents pass through a short path, prior to being discharged through the center of the plate button.

However, as shown in FIGS. 1 and 2, when a dispensing valve 1 closes an outlet hole 3, a contact area between an inner surface 4 of the outlet hole 3 and an outer surface 2 of the dispensing valve 1 is small. Further, the dispensing valve 1 may be undesirably moved up by the contents. As such, the conventional dispenser has a problem in that a seal is poor. Due to the poor seal, air may flow through a gap between the outlet hole 3 and the dispensing valve 1, thus changing the quality and color of the stored contents. Therefore, the problem must be settled without delay.

### DISCLOSURE

### [Technical Problem]

Accordingly, the present invention has been made keeping in mind the above problems occurring in the prior art, and an object of the present invention is to provide a dispenser with a sealed dispensing valve unit, which is secured to an upper portion of a hermetic casing holding a cream-type cosmetic that has high viscosity and is deteriorated by contact with air, and is provided with a button having a concave push plate with a predetermined area, thus discharging the contents upwards. This invention improves the construction of both an outlet hole formed on a central portion of the plate button and a dispensing valve closing the outlet hole, thus preventing air from flowing into the casing.

Another object of the present invention is to provide a dispenser with a sealed dispensing valve unit, in which an outlet hole provided on a central portion of a plate button and a dispensing valve fitted into the outlet hole to open or close the outlet hole are manufactured so as to form a thin sealing film using contents to be dispensed.

### [Technical Solution]

In order to accomplish the above objects, the present invention provides a dispenser with a sealed dispensing valve unit, which is secured to a mouth of a hermetic casing holding a cream-type cosmetic that is deteriorated by contact with air and has high viscosity, and discharges contents through a center of an upper plate of a button, when the button having a shape of a concave dish is pushed to operate pumping means provided under the button, the dispenser including an outlet hole bored in a concave central portion of the button, with an inclined inner surface defining a lower portion of the outlet hole and being tapered in a direction from an upper portion to a lower portion of the inclined inner surface, and a vertical inner surface extending from an upper end of the inclined inner surface to a predetermined height; and a dispensing valve having at a lower portion thereof a funnel-shaped inclined outer surface to selectively come into contact with the inclined inner surface of the outlet hole due to operation of the pumping means, thus opening or closing the outlet hole, with a vertical outer surface extending upwards from an upper end of the inclined outer surface to a predetermined height.

According to this invention, an outer diameter (d) and a height (t) of the vertical outer surface of the dispensing valve are smaller than an inner diameter (D) and a height (T) of the vertical inner surface of the outlet hole, so that some of the contents are filled between the vertical outer surface and the vertical inner surface, thus providing a sealing film.

### DESCRIPTION OF DRAWINGS

FIG. 1 is a side sectional view to show the construction of a conventional dispenser;

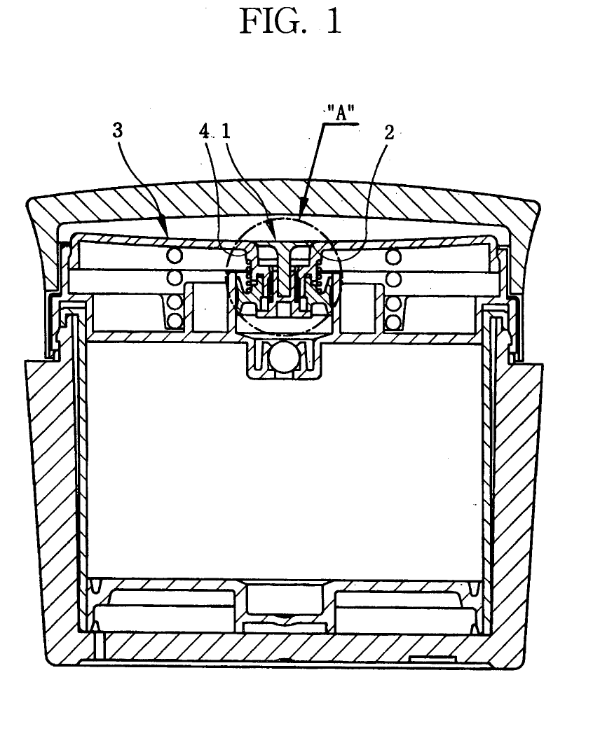

FIG. 2 is an enlarged view of portion “A”, circled in FIG. 1;

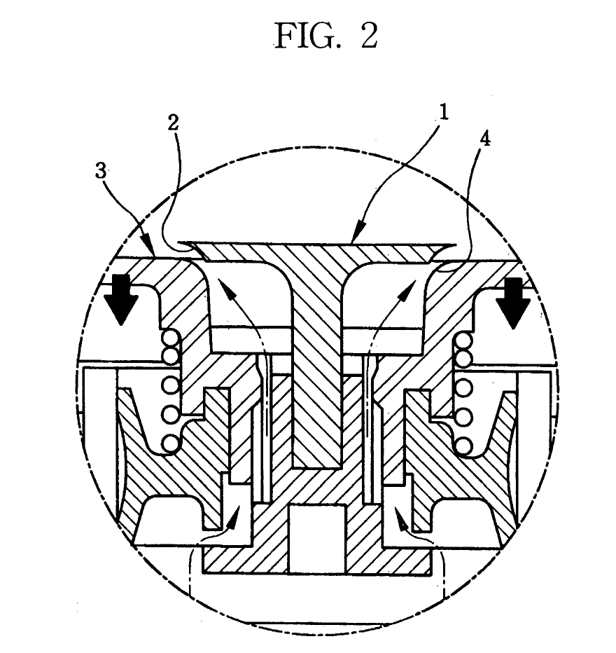

FIG. 3 is an exploded perspective view of a dispenser with a sealed dispensing valve unit, according to the present invention;

FIG. 4 is a side sectional view of the dispenser with the sealed dispensing valve unit, according to the present invention;

FIG. 5 is an enlarged view of portion “B”, circled in FIG. 4;

FIG. 6 is a view to show the state where a dispensing valve is spaced apart from an outlet hole to dispense contents; and

FIG. 7 is a view to show the state where the dispensing valve is in close contact with the outlet hole to close the outlet hole.

### BEST MODE

The preferred embodiment of this invention will be described in further detail with reference to the accompanying drawings.

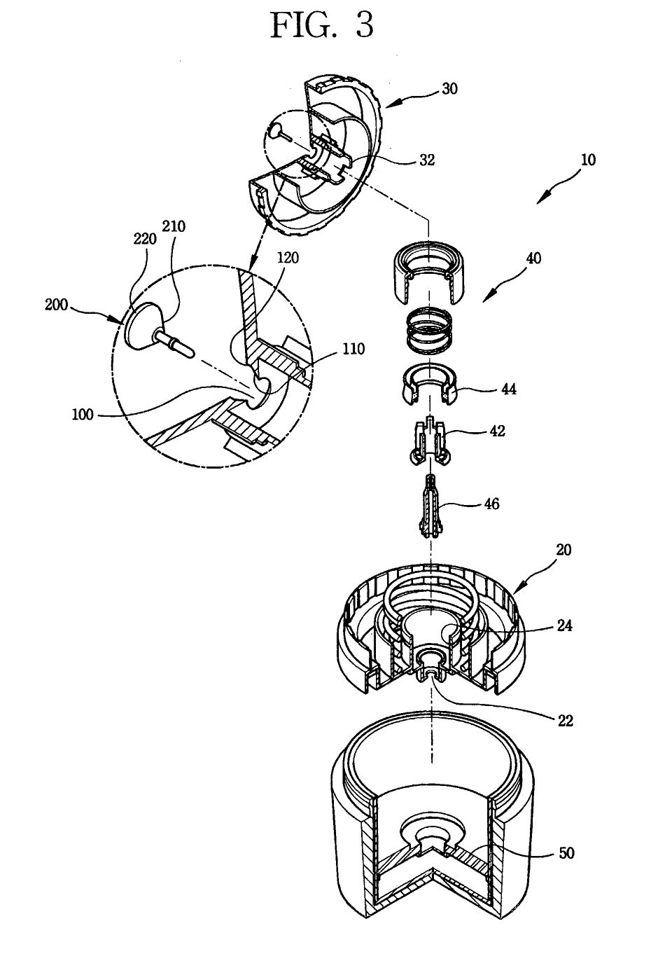

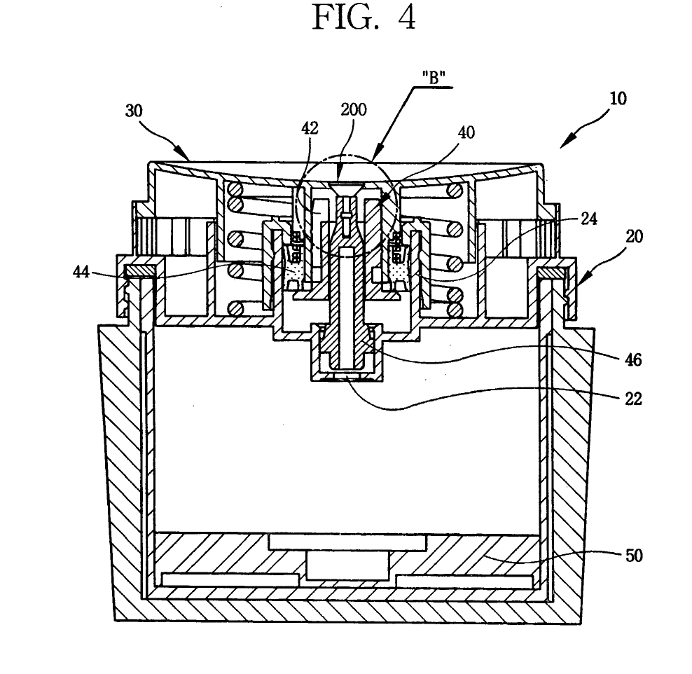

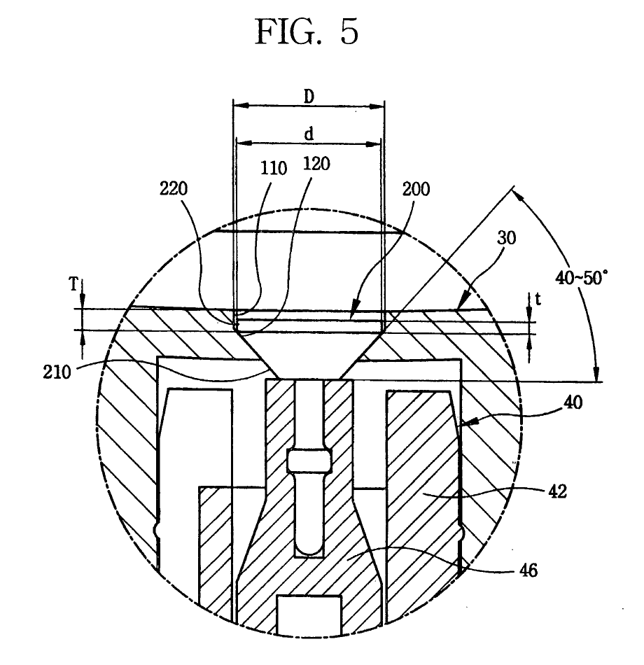

FIG. 3 is an exploded perspective view of a dispenser with a sealed dispensing valve unit, according to the present invention, FIG. 4 is a side sectional view of the dispenser with the sealed dispensing valve unit, according to the present invention, and FIG. 5 is an enlarged view of portion “B”, circled in FIG. 4.

First, the general construction of a dispenser 10 having a pumping means will be described, prior to describing the characteristics of this invention.

The dispenser 10 includes a housing 20 which is secured to a mouth of a hermetic casing to hold a cream-type cosmetic that is deteriorated by contact with air and has high viscosity. An inlet port 22 having a predetermined area protrudes downwards from a central portion of the housing 20, and is opened or closed by an inlet valve 46. A pump cylinder 24 protrudes upwards from a portion outside the inlet port 22. A button 30 is secured to a mouth of the housing 20 and is pressed down to dispense contents.

The button 30 has the shape of a dish which has a predetermined area and is concave at a center thereof. An outlet hole is bored through a central portion of the button 30 to discharge the contents. A pump stem 32 protrudes downwards from a portion outside the outlet hole, and is coupled to the pump cylinder 24 of the housing 22. Thus, while the button 30 is secured to the upper portion of the housing 20, an upper plate of the button 30 is pushed to move the button 30 vertically. At this time, a pumping means 40 installed under the button 30 is operated, thus dispensing the contents.

The pumping means 40 is installed between the pump stem 32 and the pump cylinder 24. The pumping means 40 includes a piston 42, a seal ring 44, and the inlet valve 46. The piston 42 is coupled to the pump stem 32. The seal ring 44 is in close contact with an inner surface of the pump cylinder 24, and moves vertically to control the discharge of the contents. The inlet valve 46 moves vertically in the piston 42 to open or close the inlet port. Thus, when the button 30 is pushed, the pumping means 40 moves vertically to dispense the contents.

Further, when the contents are discharged by the pumping action, a plunger 50 provided in the casing is moved by the pumping pressure, thus thrusting the contents upwards in proportion to the discharged amount of the contents. In this way, the contents are continuously dispensed.

In such a dispenser 10, this invention is characterized by the shapes of the outlet hole 100 formed on the central portion of the button 30 and a dispensing valve 200 used to open or close the outlet hole 100, and the coupling structure of the outlet hole 100 with the dispensing valve 200.

The outlet hole 100 is bored in the central portion of the button 30. An inclined inner surface 110 defines a lower portion of the outlet hole 100, and is tapered in a direction from an upper portion to a lower portion of the inclined inner surface. Further, a vertical inner surface 120 extends from an upper end of the inclined inner surface 110 to a predetermined height. In this case, the inclined inner surface 110 has an inclination angle which is suitable to enhance a seal when the dispensing valve 200 contacts the outlet hole 100, and is suitable to allow the contents to be smoothly dispensed when the dispensing valve 200 is spaced apart from the outlet hole 100.

Further, the dispensing valve 200, serving to open or close the outlet hole 100, has at a lower portion thereof an inclined outer surface 210 having a funnel shape. A vertical outer surface 220 extends from an upper end of the inclined outer surface 210 to a predetermined height. In this case, the inclined outer surface 210 of the dispensing valve 200 is completely in contact with the inclined inner surface 110 of the outlet hole 100, when the button 30 is not pushed. Meanwhile, when the button 30 is pushed, the inclined outer surface 210 is spaced apart from the inclined inner surface 110, thus allowing the contents to be dispensed through a gap between the inclined outer surface 210 and the inclined inner surface 110.

Further, an outer diameter d and a thickness d of the vertical outer surface 220 of the dispensing valve 200 are smaller than an inner diameter D and a height T of the vertical inner surface 120 of the outlet hole 100. Such a construction allows the dispensed contents to form a sealing film, when the contents are discharged through a gap between the dispensing valve 200 and the outlet hole 100, thus preventing air from flowing into the casing.

The operation of the present invention will be described hereinafter with reference to the accompanying drawings.

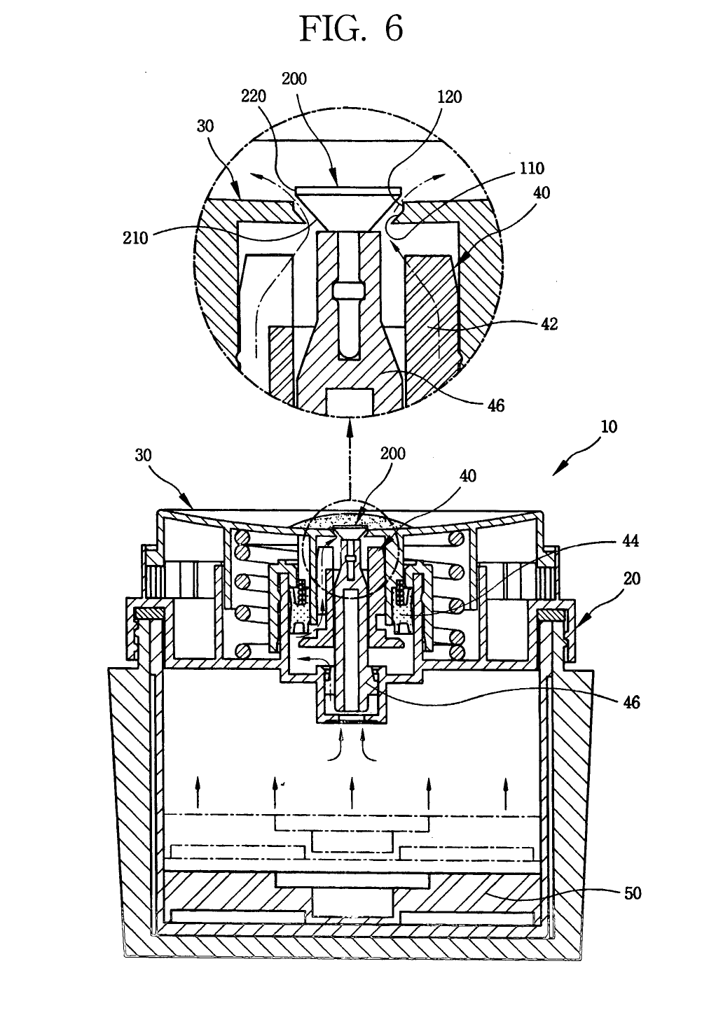

FIG. 6 is a view to show the state where the dispensing valve is spaced apart from the outlet hole to dispense contents.

In such a state where the dispenser 10 constructed as described above is secured to the mouth of the hermetic casing, a user pushes the button 30. At this time, the pumping means 40 coupled to the lower portion of the button 30 moves downwards, thus compressing the contents. Further, the inclined outer surface 210 of the dispensing valve 200 is spaced apart from the inclined inner surface 110 of the outlet hole 100, so that the contents are discharged through a gap between the inclined outer surface 210 and the inclined inner surface 110.

The contents fed through the gap between the inclined inner surface 110 of the outlet hole 100 and the inclined outer surface 210 of the dispensing valve 200 are guided between the vertical inner surface 120 of the outlet hole 100 and the vertical outer surface 220 of the dispensing valve 200, prior to being discharged in a vertical direction.

The contents discharged in this way are concentrated in one place by the vertical inner surface 120 of the outlet hole 100 and the vertical outer surface 220 of the dispensing valve 200.

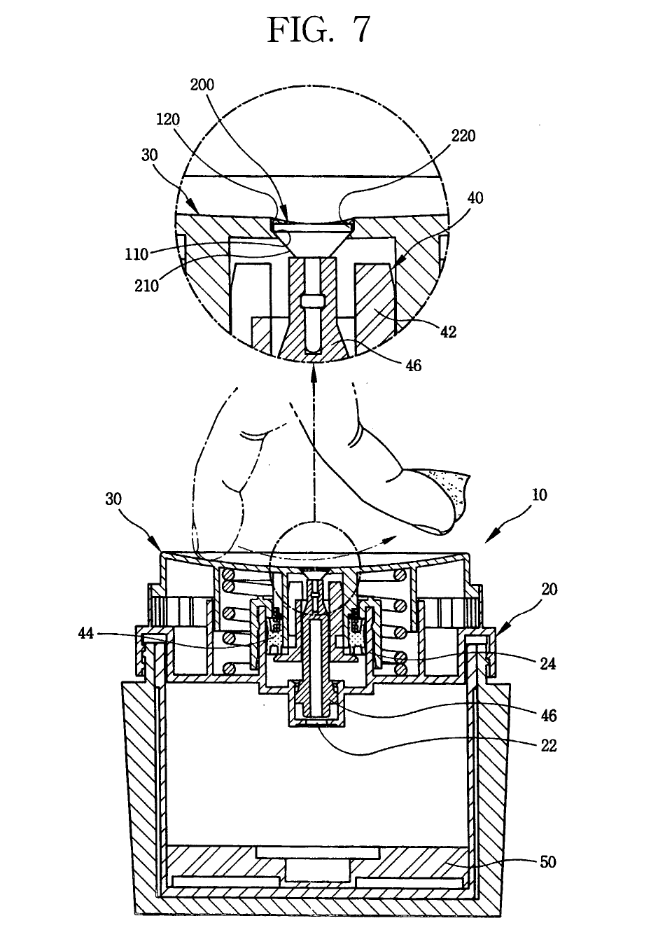

FIG. 7 is a view to show the state where the dispensing valve is in close contact with the outlet hole to close the outlet hole.

When the contents are dispensed and thereafter the button 30 is released, the button 30 is moved upwards by the pumping means 40, so that the inclined outer surface 210 of the dispensing valve 200 is in close contact with the inclined inner surface 110 of the outlet hole 100. Thereby, the outlet hole 100 is closed.

Subsequently, when the user removes the contents discharged upwards from the outlet hole 100 using her finger, the contents between the vertical inner surface 120 of the outlet hole 100 and the vertical outer surface 220 of the dispensing valve 200 provide a thin sealing film, thus preventing air from flowing into the casing.

Therefore, the above-mentioned construction and operation prevent the ingress of air into the dispenser 10, thus preventing the contents from deteriorating.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a dispenser with a sealed dispensing valve unit, which is secured to an upper portion of a hermetic casing holding a cream-type cosmetic that has high viscosity and is easily deteriorated by contact with air, and is provided with a button having a concave push plate with a predetermined area, thus discharging the contents upwards. This invention improves the construction of both an outlet hole formed on a central portion of the plate button and a dispensing valve closing the outlet hole, thus preventing air from flowing into the casing, therefore preventing the quality and color of the contents from changing, and allowing the contents to be stored and used for a lengthy period of time.

Further, according to the present invention, an outlet hole provided on a central portion of a plate button and a dispensing valve fitted into the outlet hole to open or close the outlet hole are manufactured so as to form a thin sealing film using the contents to be dispensed.

1. A dispenser with a sealed dispensing valve unit, which is secured to a mouth of a hermetic casing holding a cream-type cosmetic that is deteriorated by contact with air and has high viscosity, and discharges contents through a center of an upper plate of a button, when the button having a shape of a concave dish is pushed to operate pumping means provided under the button, the dispenser comprising:
an outlet hole bored in a concave central portion of the button, with an inclined inner surface defining a lower portion of the outlet hole and being tapered in a direction from an upper portion to a lower portion of the inclined inner surface, and a vertical inner surface extending from an upper end of the inclined inner surface to a predetermined height; and
a dispensing valve having at a lower portion thereof a funnel-shaped inclined outer surface to selectively come into contact with the inclined inner surface of the outlet hole due to operation of the pumping means, thus opening or closing the outlet hole, with a vertical outer surface extending upwards from an upper end of the inclined outer surface to a predetermined height.

2. The dispenser according to claim 1, wherein an outer diameter (d) and a height (t) of the vertical outer surface of the dispensing valve are smaller than an inner diameter (D) and a height (T) of the vertical inner surface of the outlet hole, so that some of the contents are filled between the vertical outer surface and the vertical inner surface, thus providing a sealing film.
